(19) United States
(12) Patent Application Publication
(10) Pub. No.: US 2002/0105545 A1
(43) Pub. Date: Aug. 8, 2002

(54) Method and apparatus for automatic conversion of electronic mail to an internet web site

(76) Inventors: John Carter, Mountain View, CA (US); Christopher Dobosz, San Francisco, CA (US)

Correspondence Address: GLENN PATENT GROUP, 3475 EDISON WAY, SUITE L, MENLO PARK, CA, 94025, US

(21) Appl. No.: 09/826,709

(22) Filed: Apr. 5, 2001

Related U.S. Application Data
(60) Provisional application No. 60/246,937, filed on Nov. 10, 2000.

(51) Int. Cl. G06F 13/00; G06F 3/00

(52) U.S. Cl. 345/752; 345/760

(57) ABSTRACT

a hosted Web portal where all Internet users, regardless of skill, can easily post and modify material on the Web using their existing email clients. Various tools are available for very simple authentication and site management that will ensure some degree of security and administration. For example, changing content and replacing content are provided. Hyperlinks, HTML, and embedded JPEG images in the body of the email or as attachments are supported.

### BACKGROUND OF THE INVENTION

1. Technical Field

The invention relates to public and private communications networks. More particularly, the invention relates to a method and apparatus for automatic conversion of electronic mail to an Internet Web site.

2. Description of the Prior Art

Currently it is very difficult for typical Internet users to create and post Web pages. This process is very difficult, either because it relies on complex stand alone software, e.g. HTML Editors and FTP Clients to upload the pages, or cumbersome Web site navigation to create the pages on the Web.

The following mechanisms for creating and posting Web pages are known:

22. Commercial HTML editors, such as Microsoft's Front Page, Claris' Home Page, and Adobe's Pagemill

These are much more flexible and allow more graphical sophistication, but require the ability to master new software, and these programs must be purchased. Furthermore, after the site is designed, they must be published to a Web site (as detailed herein) or a host. This is difficult too.

22. FTP clients for uploading files to server's file systems

Often FTP clients are relied upon to perform the file transfer of the Web pages on the user's computer to the hosting site. This provides the greatest flexibility of the Web structure, but is more difficult to master.

22. Commercial Internet sites, such as GeoCities.com, Tripod.com, and Homestead.com

These services allow the on-line creation of Web sites. However, these are limited in their flexibility and are relatively complex to use. They rely on special purpose editors and programs to create Web sites while logged into the sites.

It would be advantageous to provide a method and apparatus for establishing and publishing to a Web site that did not require any special skill or software.

### SUMMARY OF THE INVENTION

The presently preferred embodiment of the invention puts Internet Web publishing literally in the hands of everyone on the Internet by tremendously simplifying the process of posting a page. Now anyone who can write an email can post a page on the Internet. The invention provides a quintessential simple solution to a common problem ‘If only I had some easy way to post this to the Web! But I don't know HTML, I don't have a Web site and I don't want to spend a lot of time!’ It is most suitable for rapid development and sharing of information, with relatively modest graphic sophistication.

The preferred embodiment of the invention comprises a Web site where all Internet users, regardless of skill, can easily post and modify material on the Web using their existing email clients. Various tools are available for authentication and site management that ensure a degree of security and administration. For example, changing content, replacing content, editing content, and concatenating content are provided. Hyperlinks, HTML, and embedded JPEG images are supported in the body of the email or as attachments.

The invention is readily extended to include the ability to take attachments, such as Word files and have them automatically posted for downloading, and displayed for viewing in the browser

This solution can be used by any number of individuals, companies and organizations.

Individuals can easily post messages, text, and photographs by sending an email. This could be used for directions to an event, showing photographs of an event, posting a resume, or sharing thoughts and or projects with others.

Companies can use the invention to inform customers about inventory, sale items, and specials. The invention is especially useful for those who do not have a Web site and who are trying to communicate with customers, or who do not want to bother to set one up with a graphics design professional. Companies can also use the invention internally for teams to communicate, and for suppliers to communicate with their business partners.

Organizations can use the invention as a powerful way to communicate their message, and get advocacy from individual members. Academic institutions and societies can use this to self publish papers, written works, areas of interest, and resumes.

### BRIEF DESCRIPTION OF THE DRAWINGS

FIG. 1 is a flow diagram according to the invention in which:

FIG. 1a shows and email handler process;

FIG. 1b shows a database process and a web hosting process;

FIG. 1c shows a verification process;

FIG. 1d shows an email notification process; and

FIG. 1e shows a search engine submission process;;

FIG. 2 is a block schematic diagram showing a system architecture according to the invention; and

FIG. 3 is a tree diagram showing a directory structure according to the invention.

### DETAILED DESCRIPTION OF THE INVENTION

The invention provides a hosted Web portal where all Internet users, regardless of skill, can easily post and modify material on the Web using their existing email clients. Various tools are available for authentication and site management that ensure a degree of security and administration. For example, changing content and replacing content are provided. Hyperlinks, HTML, and embedded JPEG images in the body of the email or as attachments are supported.

There are four major functional areas that make up the product:

1. Email handling.

2. Request processing.

3. Data storage.

4. Web hosting.

An email sent to the system is read by the handler which determines if it is a valid request to post. If so, then the message is processed in the request process logic. URLs are created and the user is verified to ensure it is a valid post. Information about the user and the post is stored in a database (Data Storage). This information is processed, and the email is formatted for HTML viewing. The site is then hosted and an email is sent to the creator indicating that the page is ready for viewing.

### Process Flow

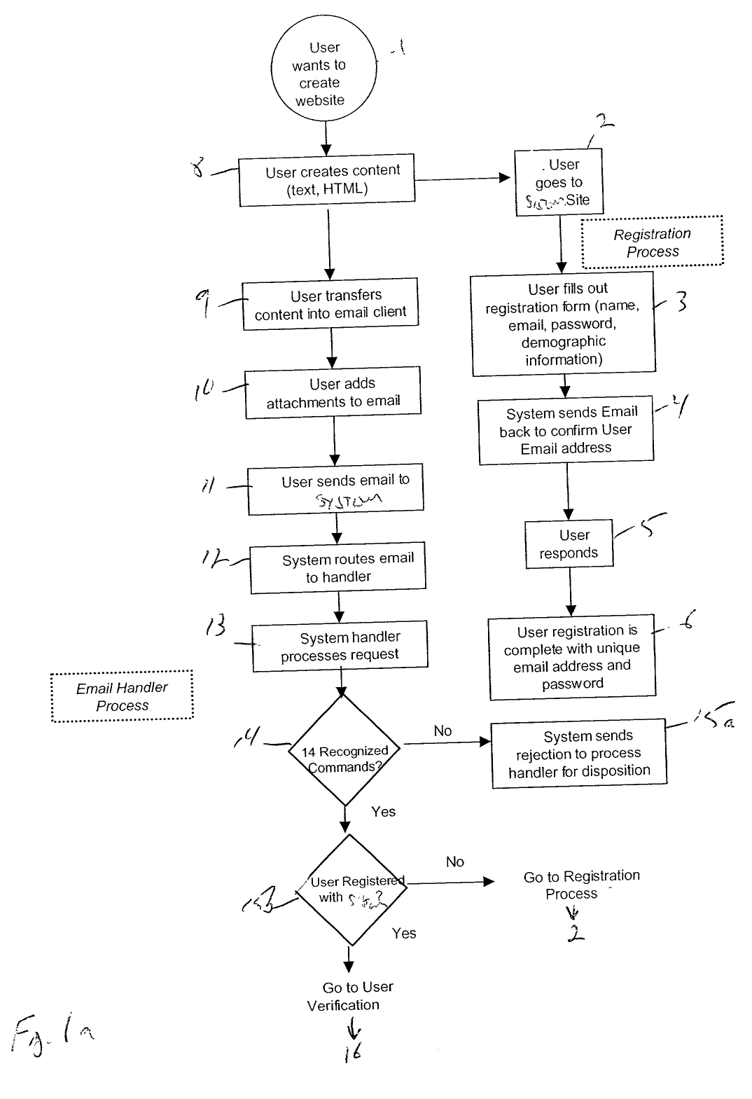

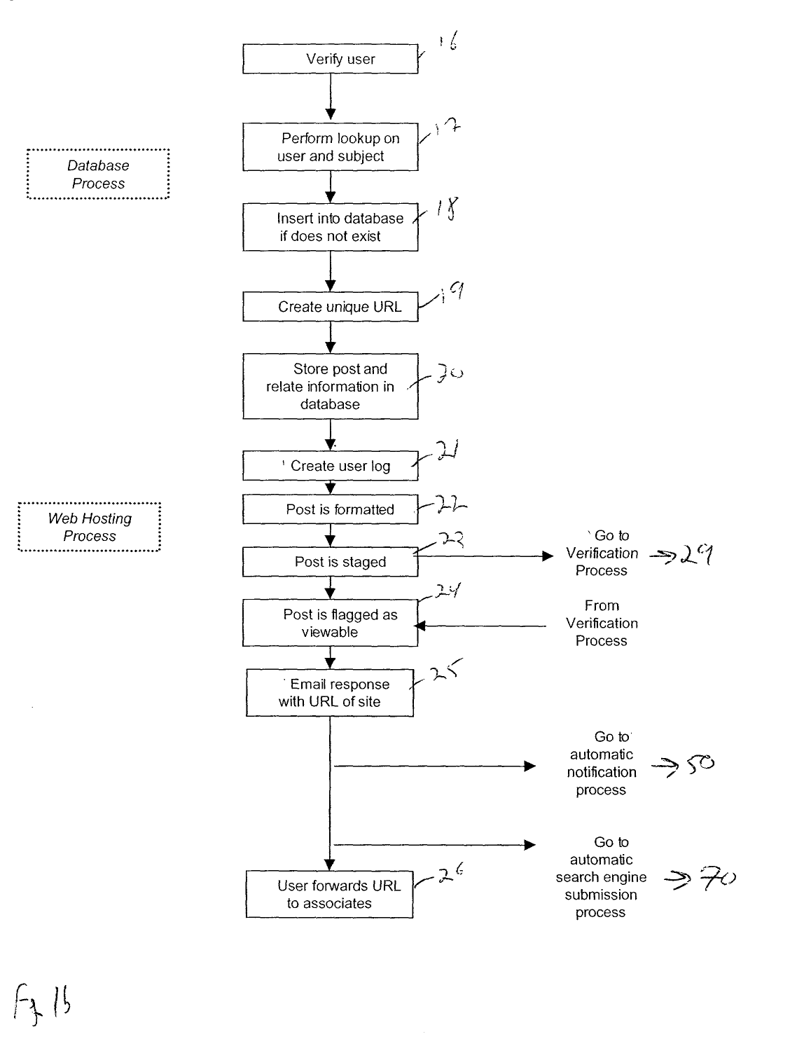

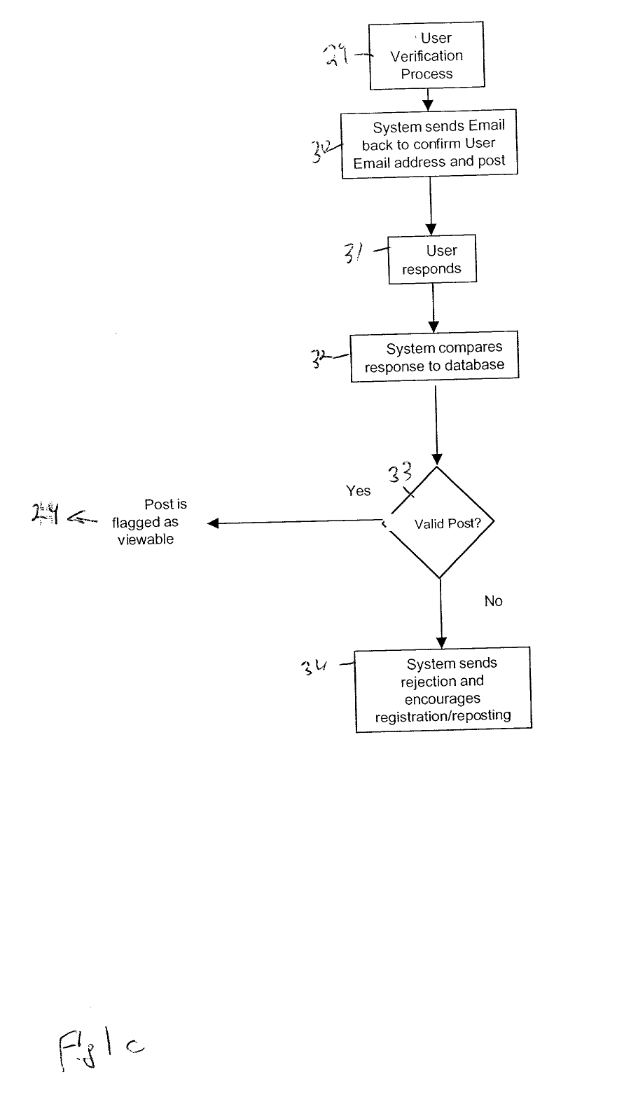

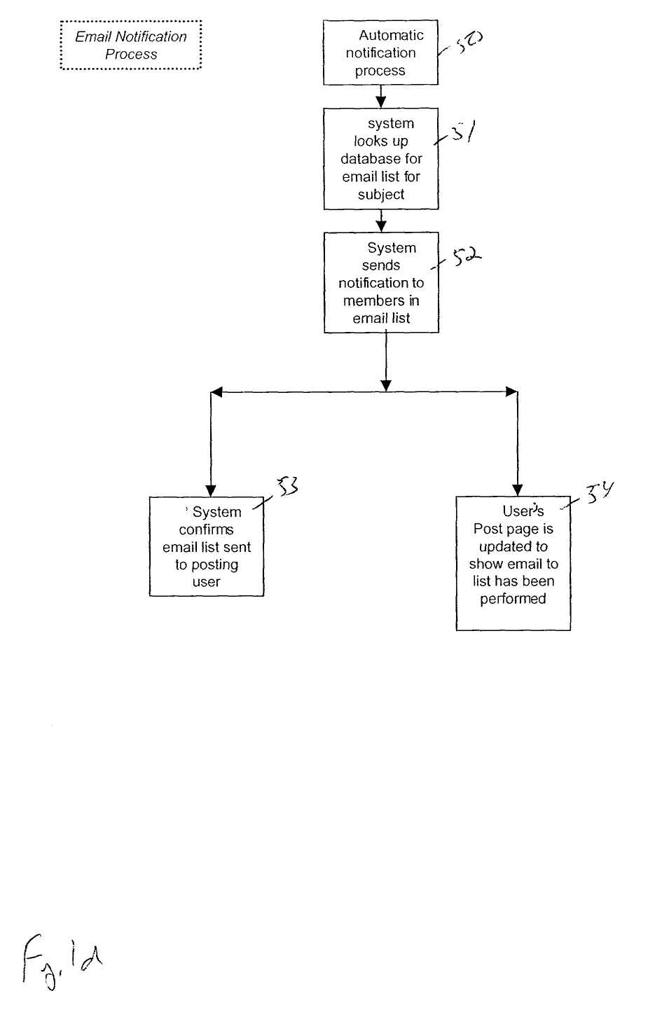

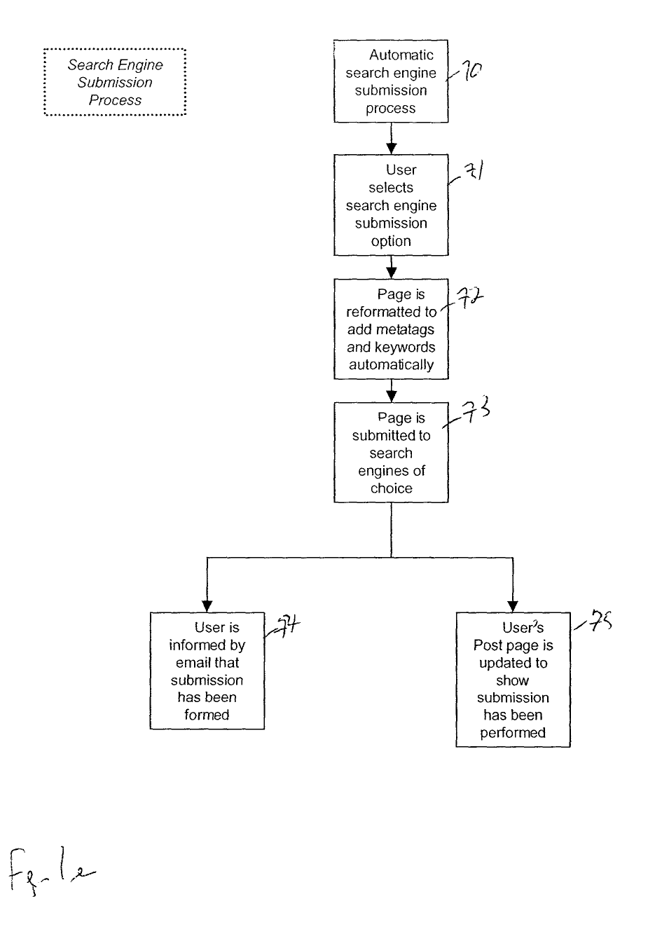

See FIGS. 1a-1e for the following discussion.

A user starts by wanting to create a Web site (1). They go to the system site directly (2) to register via the registration process (3-6) or they start creating the site directly (8). They then transfer this into the email client (9) which can be hosted on the user's computer or be a Web based email program. The user can attach files of all types to the email body (10), and send it to the system by using the email address post@the system.com (11). The system routs the email to the handler (12) and processes request (13). If the command is not recognized (14) it goes to rejection process handler (15a), if it is then it goes to verify user (15b). If the user is not recognized, then the user is taken to the system site for registration (2). If the user is registered, then post verification takes place (16). User lookup is performed (17) and database records are created (17, 18). Then a unique URL is created if a post is requested (19). The post is stored and a user log entry is then created (20-21).

To provide a suitable appearance, the post is formatted (22). The post is staged (23) and a verification process is instituted to ensure that the user did indeed generate the post (29). If the user's request is verified, then the post, which is staged (24) is flagged as viewable. An email is sent back to the user to indicate the URL of the posted information (25).

At this time possible additional process are invoked, if desired. They include automatic email notification of a group of email users via an optional process (50-54). Also optional is a process by which the site is submitted to major Web site searching programs (70-75). Either one of these, or additional processes may be performed for payment by the user. This payment session is not shown, but is easily implemented.

The user then can forward the URL of this site to associates (26).

The user verification takes place starting with step (29). The system sends an email to the registered email address of the user and the user is asked to respond (30-31). The system compares the response to the database (32). If a valid post, the post is flagged as viewable (24). If not the system sends a rejection and encourages registration and reposting (34).

### Functional Breakdown

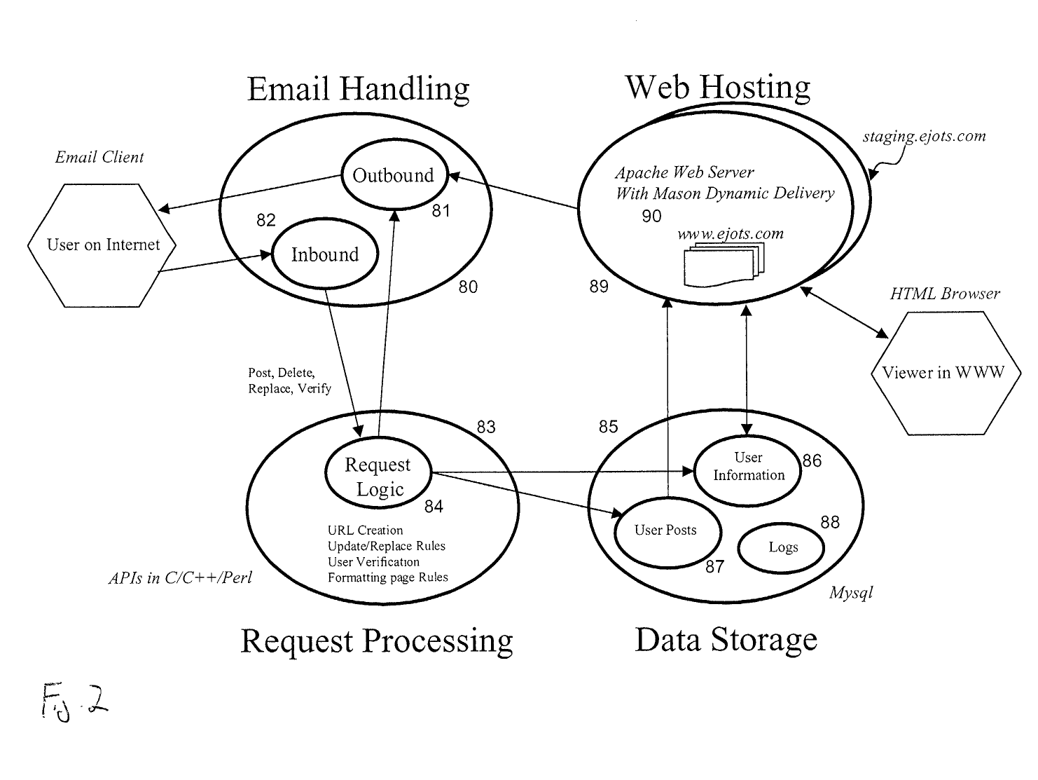

See FIG. 2 for the following discussion.

There are four major functional areas that make up the product:

email handling, request processing, data storage, and Web hosting.

The initial architecture chosen for this project is to build those four functions on a single Linux platform running public domain tools. This architecture was chosen to maximize the speed and efficiency of the prototype development process. However, the architecture is predicted to handle a moderate traffic load with reasonable speed and reliability.

### Email Handling

Email-Web handles email-based requests from Internet users. Additionally, it sends email to users to ask for verification of their email address as well as provide information about the status of their request. Thus, both outbound and inbound email handling is required (80).

### Outbound

The outbound process (81) sends HTML and text email to Internet users with customized content and reply addressing. Processing outbound mail is straightforward in the prototype environment where the volume of outbound mail is low. As the site scales the outbound mail process requires a scalable solution to provide rapid response to users. The invention contains logging algorithms to store a copy of every email sent for legal reasons. Outbound mail process APIs are constructed to allow for efficient implementation of changes to the outbound mail architecture.

### Inbound

The inbound process (82) rapidly handles email coming in to multiple mail boxes, filtering unwanted messages and directing valid requests to the appropriate functional process. Using standard mail software the inbound handler is both the gateway and the filter to the request processing algorithms. The presently preferred embodiment uses the mail address to direct the email to the appropriate process. Provided is a spam filter, filter for customer service requests, and auto rejection of email greater than a specified size. The invention includes load balancing techniques and deny rules for the purpose of avoiding denial of service attacks.

### Request Processing

Email-Web initially offers four types of actions to the Internet user: post, replace, delete, verify which is handled by Request Processing (83). An individual process designed for speed and efficiency handles each of these actions. However they have many common functions.

Each process must:

Verify user

Perform data lookup on the user and subject

Insert/update the database

Email a response

Additionally they have their own distinct functions and specific logic rule sets. This is fulfilled by the Request Logic (84).

Among these functions/rules are:

URL creation

Update or insert rule for same subject and user post

Verification of user and process state of post

Rules for formatting of Web page from email

For this reason an API is constructed for all of the common functions and the code base is shared. The processes is written separate from the Web application using C, C++, or Perl depending on the tools available to the developer.

### Data Storage

All information posted to Email-Web is stored in a database (85). For simplicity and speed, Mysql is used in the preferred embodiment. This public domain database is reliable and robust enough to handle fairly large volumes of data and requests. Search algorithms allow for finding users and their posts.

The database processing is preferably implemented on a single machine. The machine is sized and dedicated to this function.

The full database schema includes three types of information to be stored:

23. User Information,

24. User Posts, and

25. Logs.

### User Information

(name, password, email, zip code is stored in the database (86))

Demographic information is optimized for a quick and easy sign-up procedure and at the same time allow profiling. Additional demographic information can be added at any time. Standard API methods for updating and retrieving are used.

### User Posts

(unique ID, owner, URL info, post status, subject, body, date created, date last updated, number of times viewed, is also in the database (87))

This information is stored together with indexes on the unique ID, owner, and URL info for fast lookups.

### Logs

Standard convention provides tables for logging user actions and process actions such as sending emails, updating content, and deleting pages (88). Additionally deleted pages should be stored in the event there is a dispute of any kind.

Automatic processes for cleaning the database are provided. These processes look for anomalies, strip out spam, and perform other cleaning functions.

### Web Hosting

The Apache Web server with the mod_perl configuration is the base Web server application (89). A dynamic Web delivery system application layer, is used for the delivery of the site (90). This dynamic Web delivery system provides simple and open source solutions for dynamic page creation, database interaction, user session data manipulation, page caching, and email delivery.

The Web site is being developed under the domain name the system.com for the purposes of the prototype.

The Web site provides these services:

Users:

User signup

User login and authentication

Storage of session records and cookies

Posting of Web pages

HTML editing

Server:

Dynamic page generation

Email sending

Staging and Production environments

Security

Load Balancing

Additional extensions to the invention are easily implemented. These features include email notifications, discussion threads, address book, search engine, page view statistics, advanced page building logic, and auto-conversion of mime types like Microsoft Word documents.

Other elements easily included in the invention are:

Firewall Security

Post Formatting

Hardware Sizing

Bandwidth Sizing

Load Balancing

Redundancy

Data Backups

### Site

The site uses “the system.com” as the initial domain name. The invention is called the system which enables the email Web functionality. The site consist initially of about six screens that support the company's home page, registration and account management. The site look and feel is consumer/small business oriented with clean graphics, fast loading time and low graphic clutter.

1. Home—simple, including “login”, “help”, “sign up”, “about”, “search” and includes the system logo (see Table A).

TABLE A
Home

“If only I had some easy way to post this to the Web! But I don't know
how, I don't have a Web site, and I don't want to spend a lot of time or
money!”
the system
the system is the easiest way to build a Web site . . . as simple as sending
an email!
It is as easy as 1, 2, 3. 1. Sign-up: Click on the Sign-Up Page and register.
2. Verify: Enter code from automatic email sent to you. 3. Create:
Compose your Web page from email and send to post@the system.com.
the system will post your page and email the location!

2. Login—simple page with banner on the top and buttons below asks for email address and password (see Table B).

TABLE B
Login

My the system login
Email:
My the system Password:
New Users
You can join right now.- its free, and only takes seconds.
uz,1/6 Why join?
Its free, simple, and fast
Post Web pages on the Internet as simply as sending an email
Share your thoughts, opinions, and information to friends
Inform potential customers about products, sales, and specials
Post your resume or vital information to sell yourself or business
No complicated software to learn

3. Registration—Ask for minimal demographics such as first, last name, zip code, email address and password (see Table C).

TABLE C
Registration, Part 1

Join the system and create your own Web sites!
To join the system, simply fill out the fields below. Once you complete
registration, you will have access to many features available only to
registered members. We do not share your information with other
companies. See our Privacy Statement Terms of Service for more
information.
First Name:
Last Name:
Email Address: (required)
My the system Password: (required)
Confirm Password: (required)
Zip code / Postal Code: (required)
Finish (button)

4. Registration—Says that an email is sent and you must reply (see Table D).

TABLE D
Registration, Part 2

Your membership is nearly done.
To complete registration, you must follow the instructions in an email
which we will send to you at your membership email address. Please
check your email for this notification and respond to get all the benefits
of joining the system. We use this confirmation process to ensure that this
email address is yours so that your identify is protected when you post
your email pages.

5. My the system—List pages posted and dates. Allows you to delete posted pages and it includes Navigation bars to other pages and to log out (see Table E).

TABLE E
My the system

My the system

| | | | |
|---|---|---|---|
| Action | Name | Last Modified | URL |

See below for table format. Ours can be simple, but we do need
commands to delete and rename at a minimum.

6. Unregistered User Signup—Simple page that vectors you to the Registration page (see Table F).

TABLE F
Unregistered User Signup

Like to start using the system?
Please click below to get to register and get all the benefits of the system
immediately.
Start (button)
Why join?
Its free, simple, and fast
Post Web pages on the Internet as simply as sending an email
Share your thoughts, opinions, and information to friends
Inform potential customers about products, sales, and specials
Post your resume or vital information to sell yourself or business
No complicated software to learn

7. Help—Simple text page with some basic tips for now (see Table G).

TABLE G
Help

Sign up - It is as simple as 1 - Sign-up, 2 - Verification, 3. Posting
Sign-up: You must fill out registration form with all required fields. After
entering the signup information you must press submit. Please be sure to
type in your email address correctly, as this is your account name. the
system will send you an email to the email account that you registered
with a confirmation code in the email.
Verification: You must go to your email program and wait for the response
from the system with the confirmation code. You must then respond to the
email from the same email client software program, from the same
computer (typically) that you registered with.
Once you receive this, copy this code back into the system confirmation
page. This ensures that you actually registered the account.
Posting: In order to post an email as a Web page, simply compose the
email that you would like to post. Send it to post@the system.comwith
the subject as your title of the posted Web page. You may add attachments
in the form of JPEG format images to your
email posting, just by attaching
in the form of email before sending. Send the email to the system. When
your posting is ready for viewing, the system will send back an email that
has the location of the pages you have posted in a verification reply. You
can then click on the link in the verification email to view the page and
forward it to friends and associates.
Posting Pages - Simply send an email to the system. If you have not
registered, the system will send a reply that gives you instructions on how
to register. To post a Web page from and email, just send an email to post
@the system.com, with the subject of the email the title of your Web
page. the system will send you a confirming email to ensure your security.
You must reply. Once you reply the system will send you and email with
your Web page's address. You can simply click on this address to see it,
and you can forward this email to your friends and associates for viewing.
You can create as many pages as you would like.
Account Management - To erase pages, or to find out about their unique
Web address (URL), login to the system and go to Search page. Type in
your email address to get to your Posts page. There you can delete pages,
review creation dates, and get the address to send to others.
Login - Once you have signed up and verified your registration with the
system, you are able to Log In to your account. There you can manage
your account on the “Posts” page, which can be considered your home
page for any posts you have made to the system. This allows you to delete
your posts.
Logout - Once logged in to the system, you can use the LogOut button to
leave the secure login environment of the system. This brings you back to
the system main Home Page.
Searching Pages - If you would like to find your pages, or find the home
pages of other users of the system, go to the search page. Enter the email
address of the user (or yourself) and if found, the home page link will be
displayed. Just click on that home page link, and you will be brought to
that users page. If you are not looking at your own home Post page, then
you can not delete any files. If these pages are yours, then a delete button
on the right hand side can be used to delete the Web page.
Attachments - currently only a single JPEG attachment is allowed. In the
future, additional attachment types will be allowed.
Problems - send your question to help@the system.com.

8. About—Simple text page with something about the team, business development, intellectual property protection, and contact information (see Table H).

TABLE H
About

About the system
About our company
About contacting us

9. User Post—This page needs to include a frame around which the actual post is mapped. The posted page consists of exactly what the user has sent in the body of the email. The title of the page is the title in the subject line of the email. There is a frame top for the system logo (which is ehere we would do the branding, and would take us to the system home page), and a button for signup.

10. Search Page—Offers a search by the email address of the poster thus helping users to find pages without knowing to exact URL (see Table I).

TABLE I
Search Page

Can't remember the name of the link but remember the person's email
address?
Enter an email address and we'll help you find a full listing of their posts
on the system. (Searching by name and subject is not available at this
time.)

11. Verification Page—Page that asks you to enter confirmation code (see Table J).

TABLE J
Verification Page

Your membership is nearly done.

To complete registration, you must follow the instructions in an email which we have just sent to you at your membership email address name@domain.com. Please check your email for this notification and respond to get all the benefits of joining the system. We use this confirmation process to ensure that this email address is yours so that your identity is protected when you post your email pages.

### Registration Process

The user comes to the sign up page via one of two methods:

1First, just by going to the home page.

2The second is with viral use where an email is detected for posting from an unregistered user.

The reply is sent back to the user with a URL to the registration page.

The normal registration process consists of the following steps:

1. Filling out the registration form

2. Receiving an email

3. Replying to an email

The email reply brings the user to the login page for login to the site and site use.

For emails to post pages from unregistered users the process consists of the following steps

1. Email back to user indicating that they need to register

2. Filling out the registration form

3. Receiving an email

4. Replying to an email

### Posting Process

For a registered user to post by email, they must send an email to the correct address. The subject is the name of the page, and the body consists of the plain text or HTML that is posted. Attachments can be included in the email message. Currently JPEG and HTML are acceptable attachments. These are appended to the posted body of the email itself when posted.

### Page Generation/Change

There are currently the following supported actions:

1. post@the system.com—Posts an email as a Web page, with subject being the name of the page.

2. delete@the system.com—Deletes page with the same subject.

3. replace@the system.com—Replaces page with new page keeping the subject name the same.

4. verify@the system.com—User replies to a verification request via this address.

### Page Verification

An email is sent back immediately that thanks you for posting a page and asks you for a confirmation that you sent the email. Simple reply to the email is sufficient.

### Page Rejection

An email is sent back to the generator if they are not currently registered, and has a URL for the registration site. In other embodiments of the invention the page is saved so the user does not have to resend it. Also other kinds of page rejection are handled as spam.

### Page Notification

An email is sent to you with the actual URL that is generated by the system.com that confirms that the page is posted and that you can then forward this to your friends. A hyperlink at the bottom allows your friends to link to the home page of the system and sign up too.

### Special Cases

There needs to be ways to accommodate some typical out of range conditions.

In some cases a duplicate posting of the same message may occur by accident by a user say within 24 hours. This is treated as a replacement.

Some people try to reply to a message with questions or other customer service type messages. These messages are routed to the appropriate mail box.

Nonregistered users are addressed above.

Incorrect email addresses must be managed (info@the system.com . . . )

Deleting subjects that do not exist must generate an error email

Bogus reply email address must be handled at some point. Many email engines and clients add things like “pop.” to the return address username.domain.com.

### Login Process

The login procedure is very simple for the preferred embodiment. The user is presented with a screen for login (form). There are error messages if there is mistyping of the username or login. There is an ability to send the password to an email address if it is forgotten.

After successful login, the user rolls into the account management page.

### Account Management Process

Again, the account management process is very simple for the preferred embodiment. The user is able to list the names of the pages, their URLs and the date of creation.

Full account management options include changing pages, change page names, management of email notification groups, and the signup for advanced services.

### Posted Web Page Attributes

The posted page consists of exactly what the user has sent in the body of the email. The title of the page is the title in the subject line of the email. In addition, there are pop up advertisements such as those found in GeoCities, which is derived from demographics that help target the advertisement. Because the preferred embodiment cascades content, it makes sense at a minimum to have a frame top for the system logo (which is an opportunity branding, and leads to the system home page), and a button for signup. These could be one and the same. Homestead probably has the best guideline for doing this kind of organization.

There are navigation buttons to the various attachments, with labels of the actual file names in the attachments. Available features could include (download original, jump to index of all posts by this person, send this person an email, email this URL to someone,)

### System Structure

The system is an application built upon some standard Web delivery tools including a Web server, application server, database, and a mail delivery system.

The data flow model for the system is:

(1) data flows into the system from an email through mail handling processes which strip text and mime attachments,

(2) all data (including mime attachments) from email are stored in a database,

(3) users on the WWW access posted email and have access to simple functions and features such as user accounts, search, view, and delete.

The mail architecture is built on UNIX sendmail and procmail. Inbound mail for post@the system.com, replace@the system.com, delete@the system.com, and verify@the system.com is intercepted by procmail and sent to an appropriate program for handling. The handling programs are currently written in Perl but could easily be replaced by programs written in nearly any language. Please see the section titled ‘Mail Handling’ for complete documentation of this architecture.

The Web architecture is built on the Apache Web server compiled with mod_perl and a basic installation of the Mason dynamic Web delivery system. These applications are all open-source applications and can be installed on most all OS and machine platforms including UNIX (Solaris, Linux, FreeBSD, . . . ) and WIN/NT. Please see the section titled ‘Web Site’ for complete documentation of this architecture. For information on a particular application, visit:

| | |
|---|---|
| Apache: | http://www.apache.org |
| mod_perl: | http://perl.apache.org |
| Mason: | http://www.masonhq.com |

### Data Representations

The data associated with the invention include:

user information, email text, email attachments, and user actions.

All of these data are stored in a database including mime-based attachments.

the system currently uses a Mysql database. Conversion to another database application is relatively straightforward. The database for the prototype resides on the same machine as the Web server. However it is not necessary to keep the database on the same machine.

The configuration file for the host, database, user, and password for database access can be found in the Web server document root for the system under:

| | |
|---|---|
| | utils/db/getConnection |
| The primary tables are: | |
| | posts |
| | mimes |
| | users |
| The supporting tables are: | |
| | delete_posts |
| | pending_user_info |
| | replace_poSts |
| | replace_posts_archives |
| | posts_statuses |

Additionally there are tables for a project task tool built as part of the administration tool set. The task tool is not necessary for the operation of the system.

### Algorithms

There are two sets of algorithms that make up the code generated for the system:

### Mail Handling

The mail handling algorithms are written in Perl and use the MIME::Parser Perl library for parsing email. There are separate algorithms for posting, replacing, deleting, and verifying information. These routines are post.pl, replace.pl, delete.pl, and verify.pl respectively. The algorithms share some Perl subroutines contained in a common Perl file titled tools.pl. The files can sit anywhere on the file system as long as they can be reached by procmail. Procmail is invoked by forwarding email for these special mail boxes to a user on the mail handling machine and then placing a .procmailrc file in that user's home directory. The .procmailrc file is included below. The user ‘the system’ is currently being used and the Perl routines can be found under the home directory in ˜the system/mail/handling/bin.

### Web Site

The Web site algorithms are all built in Perl and are executed through the Mason dynamic delivery system running on top of Apache mod_perl. Mason is an application layer system similar to Microsoft's Active Server Pages (ASP). All Web pages are built dynamically through ‘components’, which are mixtures of HTML and Perl. These components are located within the Web server's document root. A complete site map to these components is contained in the section ‘Web Site’. The primary functions supported by these components are: database access, page formatting, display of MIME attachments, user logins, and user functions.

### Systems

There are three primary systems:

(1) Mail Handling,

(2) Web Site, and

(3) Database.

All of these systems are hosted on a Linux computer. A user with the name ‘the system’ was created on the system and all software for the system is within that directory.

The tree to the left shows the file system for the user the system. Each of these directories and the algorithms with them are described in depth in their respective sections below.

Procmail controls mail handling. Procmail is a UNIX system software process that runs in conjunction with Sendmail. Procmail allows for the intercepting of email coming to a user of the machine. Email is investigated upon receipt and can be routed to an executable program. There is a separate program for each of the user functions available via email: post, replace, delete, and verify. All mail handling programs are located in the system/mail/handling/bin directory.

Web Site software is built in conjunction with the Mason dynamic Web delivery system—an open source software application built on the Apache Web server compiled with mod_perl.

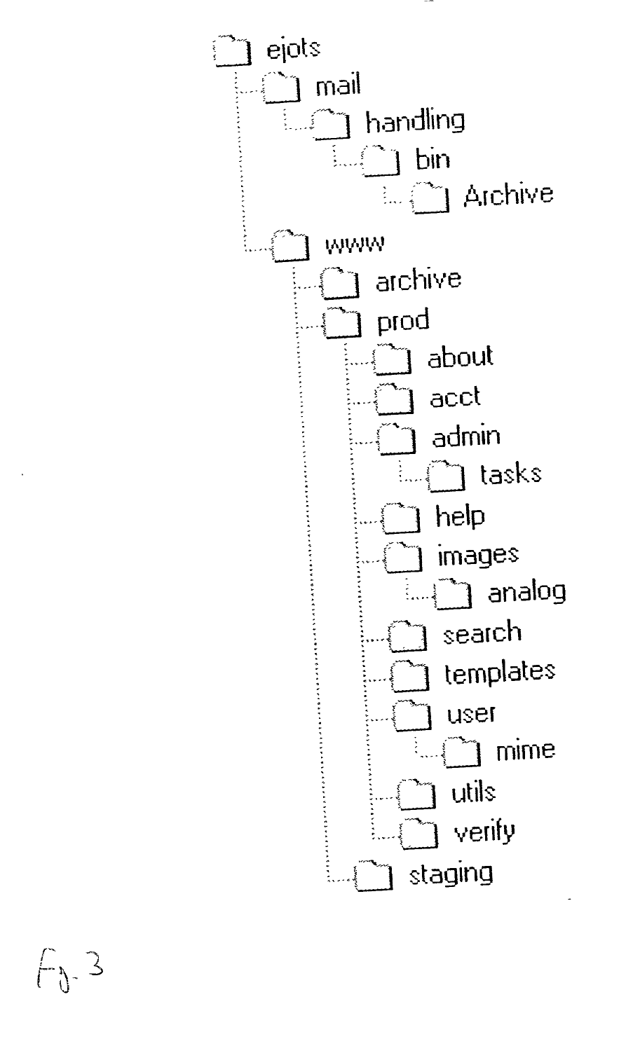

The tree in FIG. 3 shows the layout of the Web site, which has a mirrored staging and production environment.

the system uses the Mysql database. Mysql is an open-source database that can be downloaded for free from the Web site http://www.mysql.com. Mysql has many similarities to commercial databases and supports most standard SQL database commands and several commands unique to Mysql. Perl applications like the system Web site and mail handling routines access a Mysql database through the standard Perl library DBD::Mysql.

### Mail Handling

Inbound mail for the system is directed to the machine defined by the DNS MX record. The system prototype is completely contained on one server so both the mail server and the Web server are on the same machine. Any user on the mail server can receive email for the system. For simplicity a user named ‘the system’ was created. Sendmail on the mail server directs email sent to the system@the system.com to the mailbox for this user. Additionally aliases can be created for the system user. On the Web server the aliases post the system.com, replace@the system.com, delete@the system.com, and verify@the system.com are all directed to the system@the system.com. These aliases are set in the file/etc/mail/virtusertable on the mail server.

Whenever an email is received, the system must inspect that email and determine how to process it. This is accomplished using procmail. Procmail is a system level process that can be automatically invoked when an email is received. Procmail is invoked through a hidden configuration file in the users home directory called .procmailrc. The leading period in the name makes the file hidden. Procmail is very powerful and can perform a great number of functions such as auto-sending a vacation reply or routing email to an executable program. the system only uses the routing function of procmail at this time.

The system procmail configuration (˜the system/.procmailrc) looks at the To field of the email and then routes the email to the correct program:

post @ the system.com ˜the system/mail/handling/bin/post.pl
replace @ the system.com ˜the system/mail/handling/bin/replace.pl
delete @ the system.com ˜the system/mail/handling/bin/replace.pl
verify @ the system .com ˜the system/mail/handling/bin/verify.pl

A copy of the procmail configuration file is provided below. Note: for procmail to work correctly, the home directory for the user must not be group writeable.

### Code and Files

### Language—Perl

All of the mail handling programs are written in Perl. The choice to use Perl was made for development speed of the prototype. Later versions may be written in other languages and can be swapped into the system simply by changing the ˜the system/.procmailrc file to reflect the new algorithm.

### Necessary Libraries

The programs require the Perl libraries:

MIME::Parser

DBD::Mysql

### Temporary Files

Temporary files created by MIME::Parser are placed in/tmp. Be sure there is a process running on the machine to keep/tmp from filling the disk.

### Log Files

Log files are created in ˜the system/mail/handling/logs.

### Algorithms

post.pl

Description: Processes email sent to post@the system.com. Inspects the email header and strips the from address and subject. Uses Mime::Parser to parse the individual elements of the email. Concatenates all the text/html elements to produce the primary post message. Stores each of the mime attachments in the database. Sends an email back to the user.

Inputs: Receives email message directly from procmail.

Outputs: Stores all email attachments and body in the database. Creates a new user in the database if the from email addresses does not yet exist. Sends a reply email to the user.

replace.pl

Description: Processes email sent to replace@the system.com. Inspects the email header and strips the from address and subject. Uses Mime::Parser to parse the individual elements of the email. Concatenates all the text/html elements to replace the primary post with a matching subject in the database for that user. Stores each of the mime attachments in the database. Sends an email back to the user.

Inputs: Receives email message directly from procmail.

Outputs: Stores all email attachments and body in the database. Sends a reply email to the user.

delete.pl

Description: Processes email sent to delete@the system.com. Inspects the email header and strips the from address and subject. Marks the post in the database as deleted if it matches both the subject and from email address. Sends an email back to the user.

Inputs: Receives email message directly from procmail.

Outputs: Updates information in the database. Sends a reply email to the user.

verify.pl

Description: Processes email sent to verify@the system.com. Verify messages are required to replace and delete messages as well as sign-up for the system service. Inspects the email header and strips the from address and subject. Inspects the subject to determine the action being verified and the verification code. Checks the database for a matching verification code for that action. Updates the database accordingly. Sends an appropriate message back to the user.

Inputs: Receives email message directly from procmail.

Outputs: Updates the database. Sends a reply email to the user.

Verify routines.pl

Description: Contains individual verification processes for post, replace, delete, and sign-up. Required by the verify.pl program.

Inputs: Subroutines called by main of verify.pl.

Outputs: Returns values to main of verify.pl.

tools.pl

Description: Contains subroutines shared by the other programs such as sending email and accessing the database.

### Web Site

The Web site is built entirely on open-source software. The underlying Web server is Apache. The only module that must be included is the module from the Apache/Perl Integration Project (mod_perl). The purpose of mod_perl is to include a running Perl interpreter in every Apache thread thus eliminating the startup/shutdown time for a Perl interpreter. Because the interpreter is already running, Perl routines run orders of magnitude faster than they run in a cgi-bin directory of a standard Apache server.

The dynamic delivery application is Mason. Mason is a Perl-based page server application built specifically to run on Apache mod_perl. Mason allows for the inclusion of Perl code embedded in HTML pages. The concept is nearly identical to Microsoft's Active Server Pages (ASP). Using Mason a Web site is constructed with the ability to call individual parts of a page from various ‘components’ within the document root.

A copy of the Apache configuration file is included below to show how Mason is incorporated into the Apache server. Also below is a copy of the Mason configuration file that shows where document and component roots are established. Once Apache mod_perl with Mason is running on the server a symbolic link from the component root called ‘the system’ must be made to the directory ˜the system/www/prod. See FIG. 3 for the directory tree.

The ˜the system/www/prod directory thus becomes the document root for the Web server.

The notation used in naming files within the document root is:

html extension is a page intended to be called from a URL

all lower case is either a simple component or a primary script such as a search page

lowercaseUpperCase is a component that returns either a value or HTML and is only intended to be called by another component and not from a URL by a user

Going through each of the components within the document root of the Web site and describing inputs/outputs and function would be tedious and not worthwhile in this document. Instead a discussion of the primary interfaces that require Perl code are described and supporting components named.

From this point it is assumed that the reader has a basic understanding of Mason which can be obtained by reading the Mason documentation http://www.masonhq.com/docs/manual/.

### Interfaces

Database Connectivity

All of the database connectivity is routed through three database interface components in the directory utils/db: getconnection, getResults, and execute. These components are an application interface to the DBD::Mysql library. Thus, if future versions of the system switched to an Oracle or SQL Server database, these are the only components that should require updating.

### User Login

Through the Apache Web server and the Mason configuration file, all Mason components have access to set and retrieve session data. User logins are performed by comparing login and password to a database and then setting values in the session accordingly. Any component that should behave differently according to login status can check the session. All of the components associated with signing up, logging in, and logging out are contained in the acct directory.

### Page Design

Using the component nature of Mason, all pages are formatted using a hierarchical template technique. The master templates are contained in the templates directory. Thus, the entire site design can be changed by simply altering two components.

### User's Post Page and Mime Attachments

User's post pages and mime attachments are dynamically drawn from the database. Neither of these elements exists as a flat file on the file system at any point. Instead the information is drawn from the database and mimes are streamed to the user's browser with the correct mime type. All of the components necessary to show the user's post or mime attachments are contained in the directory user.

### Search

Simple searches are provided that utilize the database's searching ability. For this reason there is no full text search. However several methods for providing a full text search are available given the appropriate resources.

### Database

The original database chosen for the system is Mysql. Mysql is an open source software application that has a rapidly growing user community and tests well against large commercial database applications in simple storage, indexing, and retrieval functions. The database requirements of the system are extremely simple. All database requests are simple retrievals with a key that has been indexed. There are no mathematical functions that would require high CPU usage. However, due to the potentially large size of mime attachments, the Mysql daemon should be started with the max_allowed_packet option set to the largest allowable attachment file size. For instance to set the maximum file size to 6MB, the Mysql daemon should be started as this:

>safe_mysqld -O max_allowed_packet=6M

### Schema Design

The primary data types contained in the database are:

user information, posts, and mime attachments.

Thus there are three primary tables:

users, posts, and mimes

There are a couple of supporting tables where data is held prior to verification.

### Tables

The full table definitions are included below.

users:

| | | |
|---|---|---|
| user_id | int(10) | unique ID used as |
| | | reference in other |
| | | tables |
| firstname | varchar(24), | |
| lastname | varchar(24) | |
| email | varchar(128) | |
| password | varchar(12), | chosen by user |
| cookie_id | varchar(32), | not used at this time |
| status | tinyint(3) | 0 = inactive, |
| | | 1 = active |
| zipcode | varchar(12), | |
| userdir | varchar(16) | combination of |
| | | dir_prefix & |
| | | dir_suffix |
| dir_prefix | varchar(8), | first 8 characters of |
| | | email address |
| dir_suffix | int(10) | numerical count of |
| | | identical dir_prefix |
| created | datetime, | |
| last_updated | timestamp(14), | |

posts:

| | | |
|---|---|---|
| post_id | int(10) | unique ID |
| user_id | int(10) | references users table |
| subject | varchar(128), | same as subject field |
| | | of email |
| body | text, | text/html body of |
| | | email |
| status | tinyint(4) | References |
| | | post_statuses |
| private | enum(′0′,′1′) | Not currently used |
| created | datetime, | |
| last_updated | timestamp(14), | |
| verif_code | varchar(8), | stores code sent to |
| | | user's email address |

mimes:

| | | |
|---|---|---|
| mime_id | int(10) | unique ID |
| post_id | int(10) | references post table |
| mime_name | varchar(128), | derived from attach- |
| | | ment name in email |
| mime | longblob, | binary mime data |
| mime_type | varchar(32), | mime type for stream- |
| | | ing to users browser |
| created | datetime, | |
| last_updated | timestamp(14), | |

delete_posts: (posts awaiting verification from user before being deleted)

| | | |
|---|---|---|
| id | int(10) | unique ID |
| post_id | int(10) | references post table |
| verif_code | varchar(8) | code sent to user's |
| | | email |
| submitted | datetime, | |
| status | enum(′pending′,′deleted′,′expired′) | |

pending_user_info: (user information awaiting verification
from user before being added to users table)

| | | |
|---|---|---|
| id | int(10) | unique ID |
| user_id | int(10) | references users table |
| firstname | varchar(24), | |
| lastname | varchar(24), | |
| password | varchar(12), | password submitted by |
| | | user |
| zipcode | varchar(12), | |
| verif_code | varchar(8), | code sent to user |
| submitted | timestamp(14), | |
| status | enum(′pending′,′expired′,′verified′) | |

post_statuses: (status descriptions of posts -
active, deleted, waiting verification)

| | |
|---|---|
| status_id | tinyint(4) |
| status_desc | varchar(24), |

replace_posts: (replacement post body awaiting verification by user)

| | | |
|---|---|---|
| id | int(10) | unique ID |
| post_id | int(10) | references posts table |
| verif_code | varchar(8) | code sent to user |
| submitted | datetime, | |
| status | enum(′pending′,′replaced′,′expired′), | |
| subject | varchar(128), | subject from email |
| body | text, | text/html |

replace_posts_archives: (old post text/html replaced by new text/html)

| | | |
|---|---|---|
| id | int(10) | unique ID |
| post_id | int(10) | references posts table |
| subject | varchar(128), | old subject |
| body | text, | old text/html body |
| last_updated | timestamp(14), | |

### Interfaces

Both the mail handling routines and the Web site components access the Mysql database through the DBD::Mysql interface. However the Web site components utilize a common three component interface to the database while the mail handling routines only share a common database connection routine. The interface to Mysql can be switched to a standard DBI interface without much effort but was not done for this project to use pre-existing code and thus increase speed of development.

### How to Build the Program

A compressed archive file (the system_{—}0_{—}1.tar.gz) has been created with all of the software for the system. This archive file is intended for use on a Linux system already running Apache with mod_perl and Mason as well as a working Mysql database. Here are the step-by-step instructions for installing the system Web site:

1. Create a user on the mail server to receive email for the system.

2. Create aliases for post@the system.com, replace@the system.com, delete@the system.com, and verify@the system.com on the mail server. Aliases can be created by adding them to/etc/mail/virtusertable and then running the command: makemap hash virtusertable.db<virtusertable and then running the command: killall -1 sendmail.

3. Uncompress the archive file (the system_{—}0_{—}1.tar.gz) in the home directory for the user receiving mail. Be sure the user's home directory does not have group write permission or procmail does not work.

4. If the Web server is being run on a separate machine, move the www directory to the Web server machine.

5. Create a symbolic link in the Mason component root for the -<the systemuser>/www/prod. For instance if the user is the system and the Mason component root is under/usr/local/mason the command would be: In -s ˜the system/www/prod/usr/local/mason/comps/src/the system.

6. Add these lines to the Apache httpd.conf configuration file if they don't already exist:

PerlRequire mason/handler.pl
<Location />
SetHandler pen-script
PerlHandler HTML::Mason
</Location>

7. Create a database called the system on a Mysql instance that can be reached by the Web server and mail server machines.

8. Create a user and password to connect to the system database.

9. Apply the SQL table definitions (Appendix D) to populate the system database. This can be done by running a Mysql command from the command line of the machine using the system.sql file now located in the ˜the system directory. The command is:

mysql_h host-u user -p database < the system.sql

The host is assumed to be localhost if it is left out of the command.

10. Update the component ˜the system/www/prod/utils/db/getConnection with the correct host, username and password for the Mysql instance.

the system should now function on the new Web site if the DNS and MX records are correct and up to date.

### Additional Files

Several files are created on the file system during normal operation of the system Web site. These files are nominally located in the/tmp directory.

1. Full email messages received and processed by the system including mime attachments are stored by the MIME::Parser library in/tmp with a directory name that is unique and tied to the time the mail message was received. These directories and their files can be deleted at any time.

2. Conversion of Microsoft Word documents to HTML is currently handled by a process called word2html. The process converts the mime to HTML and temporarily stores the file in/tmp. Files older than an hour may be deleted. Additionally a symbolic needs to exist in ˜the system/www/staging/user/word2html to/tmp/word2html.

3. Content Management for the system can be found under http://staging.the system.com/cm. The security for Content Management is handled at the Web server level. Thus auth must be set up for the directory/cm on the staging server and user names and passwords must be created in the appropriate place for the instance of the Apache Web server.

Procmail Configuration File (˜the system/.procmailrc)

# Please check if all the paths in PATH are reachable, remove the ones that
# are not.
PATH=$HOME/bin:/usr/bin:/bin:/usr/local/bin:.

| | |
|---|---|
| MAILDIR=/home/www/the system/mail | # You'd better make sure it exists |

| | |
|---|---|
| #DEFAULT=$MAILDIR/handling/logs | # uncomment this to send mail to a dir |

LOGFILE=$MAILDIR/handling/logs/procmail
LOCKFILE=$MAILDIR/.lockmail
#_DIRECT EMAIL TO CORRECT PROCESS_#
#_POST_#
:0 fwhb
*\hat{ }To:.*post @ the system.com
|perl $MAILDIR/handling/bin/post.pl
:0:
*\hat{ }To:.*post @ the system.com
$MAILDIR/handling/posts
#_(once this is working change from

#individual directories to/dev/null)_#

#_POST(S) ALIAS_#
:0 fwhb
*\hat{ }To:.*posts @ the system.com
|perl $MAILDIR/handling/bin/post.pl
:0:
*\hat{ }To:.*posts @ the system.com
$MAILDIR/handling/posts
#_(once this is working change from

#individual directories to/dev/null)_#

#_VERIFY_#
:0 fwhb
*\hat{ }To:.*verify@ the system.com
|perl $MAILDIR/handling/bin/verify.pl
:0:
*\hat{ }To:.*verify@ the system.com
$MAILDIR/handling/verifies
#_DELETE_#
:0 fwhb
*\hat{ }To:.*delete@ the system.com
|perl $MAILDIR/handling/bin/delete.pl
:0:
*\hat{ }To:.*delete@ the system.com
$MAILDIR/handling/deletes
#_REPLACE_#
:0 fwhb
*\hat{ }To:.*replace@ the system.com
|perl $MAILDIR/handling/bin/replace.pl
:0:
*\hat{ }To:.*replace@ the system.com
$MAILDIR/handling/replaces
#_TEST POST_#
:0 fwhb
*\hat{ }To:.*test@ the system.com
|perl $MAILDIR/handling/bin/testpost.pl
:0:
*\hat{ }To:.*test@ the system.com
$MAILDIR/handling/tests

Apache Configuration File (httpd.conf)

ServerType standalone
#Port 80
#HostnameLookups on
HostnameLookups off
User nobody
Group nobody
BrowserMatch Mozilla/2 nokeepalive
ServerAdmin Webadmin @ dobosz.com
ServerRoot/www/http
#BindAddress 207.20.37.92:80
ErrorLog logs/error_log
TransferLog logs/access_log
#TransferLog “|/www/http/bin/rotatelogs logs/access_log 86400”
LogFormat “%h %I %u %t \”%r\“%s %b \”%{Referer}i\“\”%{User-Agent}\””
combined
PidFile logs/httpd.pid
ScoreBoardFile logs/apache_status
ExtendedStatus On
ServerName jape.dobosz.com
Timeout 300
KeepAlive On
MaxKeepAliveRequests 30
KeepAliveTimeout 15
MinSpareServers 1
MaxSpareServers 5
StartServers 2
MaxClients 150
MaxRequestsPerChild 30
Listen 192.168.0.4:80
Listen 192.168.0.4:10000
NameVirtualHost 192.168.0.4:*
PerlRequire mason/handler.pl
<VirtualHost 192.168.0.4:*>

ServerName www.the system.com
ServerAlias the system.com
DocumentRoot /www/http/docs/prod/src/the system\
ErrorLog logs/the system/error_log
Custom Log “|www/http/bin/rotatelogs /www/http/logs/the

system/access_log 86400“combined

DirectoryIndex index.html index.htm
<Location />

SetHandler perl-script
PerlHandler HTML::Mason

</Location>
<Location /admin>

AuthName “the system Private”
require valid-user

</Location>

</VirtualHost>
<VirtualHost 192.168.0.4:*>

ServerName staging.the system.com
DocumentRoot /www/http/docs/staging/src/the system/

ErrorLog logs/the system/staging-erro_log
CustomLog “|/www/http/bin/rotatelogs /www/http/logs/the system/staging-

access_log 86400”combined

DirectoryIndex index.html index.htm
<Location />

SetHandler perl-script
PertHandler HTML::Mason

</Location>
<Location />

AuthName “the system Private”
require valid-user

</Location>

<VirtualHost>

Mason Configuration File (handler.pl)

#/usr/bin/perl
use HTML::Mason;
use strict;
# Modules you want to use from components
{ package HTML::Mason::Commands;

| use vars qw(%session); | |
|---|---|
| use HTML::Mason::Preview; | |
| use URI::Escape; | |
| use Mysql; | |
| use Date::Manip; | |
| use Data::Dumper; | |
| use Fcntl; | |
| use MLDBM; | # * Starred mods are available on CPAN |
| use Image::Size; | # * The rest are bundled |

use File::PathConvert; #*
use File::Copy;
use File::Find;
use IO::Handle;
use IPC::Open2;
use Apache::Session;

# use Apache::Session::File;

use Apache::Session::DBI;
use DBI;
use DBD::mysql;

}
package HTML::Mason; # create Mason objs and handler within Mason
package
my $parser = new HTML::Mason::Parser;
my $interp = new HTML::Mason::Interp (parser= > $parser,

comp_root=>‘/www/http/docs/prod/src’,
data_dir=>‘/www/http/docs/prod/’);
sub handler
{

my ($r) = @_;
my $return_code;
# Explicitly set DateManips Time Zone #
#Date_Init(“TZ=PST”);
# Don't handle images
return -1 if $r->content_type & & $r->content_type !˜ m|\hat{ }text/|io;
#Set up session array
#Create a session hash
my % session;
# Read the cookie from the client
#my $cookie = $r->header_in(‘Cookie’);
# Set $cookie to the value of the SESSION_ID
#$cookie =˜s/SESSION_ID=(\w*)/$1I/;
#Read the cookie from the client
my $cookie = $r->header_in(‘Cookie’);
#Set $cookie to the value of the SESSION_ID
if ($cookie =˜m/SESSION_ID/) {

$cookie =˜s/SESSION_ID=(\w{16})/$1/;
$cookie = $1;

} else {

undef $cookie;

}
# Run inside an eval statement to catch an error if
#the session values were removed from the cache directory
eval {

# tie %session, ‘Apache::Session::File’, $cookie, {‘Directory’=>
‘/tmp/session’};

tie %session, ‘Apache::Session::DBI’, $cookie, {

DataSource => ‘dbi:mysql:sessions’,
UserName => ‘sessionuser’,
Password => ‘ready4mysession’

};
};
# If an error occurred, set the SESSION_ID to one (1)
# unless it's already set to one (1)
if ($ @ ) {

# $r->header_out(“Set-Cookie”=>“SESSION_ID=$session {_session_id};
“);

$r->header_out(“Set-Cookie”=>“SESSION_ID=1;”) if ($cookie!=1 );
}else {

# If no error occurred, set the SESSION_ID if no cookie exists
$r->header_out(“Set-Cookie”

=>“SESSION_ID=$session{_session_id}; path=V”) if (!$cookie);

}
local *HTML::Mason::Commands::session = \%session;
# Compute port number from Host header
my $host = $r->header_in(‘Host’);
my ($port) = ($host=˜/:([0-9]+)$/);
$port = 80 if (!defined($port));
#Handle previewer request on special ports
if ($port >= 5001 && $port <= 5005) {

my $interp = new HTML::Mason::Interp (parser=>$parser,

comp_root=>‘/www/http/docs/staging/src’
data_dir=>‘/www/http/docs/staging/’);

my $ah = new HTML::Mason::ApacheHandler (interp=>$interp;
return HTML::Mason::Preview::handle_preview_request($r,$ah);

} elsif ($host = ˜/\hat{ }staging/) {

my $interp = new HTML::Mason::Interp (parser=>$parser,

comp_root=>‘/www/http/docs/staging/src’,
data_dir=>‘/www/http/docs/staging/’);

my $ah = new HTML::Mason::ApacheHandler
(interp=>$interp,error_mode=>‘html’);
$return_code = $ah->handle_request($r);

} elsif ($port == 10000) {

my $ah = new HTML::Mason::ApacheHandler

(interp=>$interp,error_mode=>‘html’);

$return_code = $ah->handle_request($r);

}else {

my $ah = new HTML::Mason::ApacheHandler

(interp=>$interp,error mode=>‘fatal’);

$return_code = $ah->handle_request($r);

}
# Release the tie
eval {

untie %HTML::Mason::Commands::session;

}:
return $return_code;

}
1;

Database Schema

CREATE TABLE delete_posts (

id int(10) unsigned DEFAULT ‘0’ NOT NULL auto_increment,
post_id int(10) unsigned DEFAULT ‘0’ NOT NULL,
verif_code varchar(8) DEFAULT “NOT NULL,
submitted datetime,
status enum(‘pending’,‘deleted’,‘expired’) DEFAULT ‘pending’,
PRIMARY KEY (id),
KEY post_id_idx (post_id),
KEY verif_code_idx (verif_code)

);
CREATE TABLE mimes (

mime_id int(10) unsigned DEFAULT ‘0’ NOT NULL auto_increment,
post_id int(10) unsigned DEFAULT ‘0’ NOT NULL,
mime_name varchar(128),
mime longblob,
mime_type varchar(32),
created datetime,
last_updated timestamp(14),
PRIMARY KEY (mime_id),
KEY post_idx (post_id)

);

CREATE TABLE pending_user_info (
id int(10) unsigned DEFAULT ‘0’ NOT NULL auto_increment,
user_id int(10) unsigned DEFAULT ‘0’ NOT NULL,
firstname varchar(24),
lastname varchar(24),
password varchar(12),
zipcode varchar(12),
verif_code varchar(8),
submitted timestamp(14),
status enum(‘pending’,‘expired’,‘verified’) DEFAULT ‘pending’,
PRIMARY KEY (id),
KEY user_id_idx (user_id)

);
CREATE TABLE post_statuses (

status_id tinyint(4) DEFAULT ‘0’ NOT NULL auto_increment,
status_desc varchar(24),
PRIMARY KEY (status_id)

);
CREATE TABLE posts (

post_id int(10) unsigned DEFAULT ‘0’ NOT NULL auto_increment,
user_id int(10) unsigned DEFAULT ‘0’ NOT NULL,
subject varchar(128),
body text,
status tinyint(4) DEFAULT ‘0’,
private enum(‘0’,‘1’) DEFAULT ‘0’,
created datetime,
last_updated timestamp(14),
verif_code varchar(8),
PRIMARY KEY (post_id),
KEY user_idx (user_id)

);
CREATE TABLE replace_posts (

id int(10) unsigned DEFAULT ‘0’ NOT NULL auto_increment,
post_id int(10) unsigned DEFAULT ‘0’ NOT NULL,
verif_code varchar(8) DEFAULT” NOT NULL,
submitted datetime,
status enum(‘pending’,‘replaced’,‘expired’),
subject varchar(128),
body text,
PRIMARY KEY (id),
KEY post_id_idx (post_id),
KEY verif _code_idx (verif_code)

);
CREATE TABLE replaced_posts _archives (

id int(10) unsigned DEFAULT ‘0’ NOT NULL auto_increment,
post_id int(10) unsigned DEFAULT ‘0’ NOT NULL,
subject varchar(128),
body text,
Last_updated timestamp(14),
PRIMARY KEY (id)

);
CREATE TABLE users (

user_id int(10) unsigned DEFAULT ‘0’ NOT NULL auto_increment,
firstname varchar(24),
lastname varchar(24) DEFAULT” NOT NULL,
email varchar(128) DEFAULT ” NOT NULL,
password varchar(12),
cookie_id varchar(32),
status tinyint(3) unsigned DEFAULT ‘1’,
zipcode varchar(12),
userdir varchar(16) DEFAULT” NOT NULL,
dir_prefix varchar(8),
dir_suffix int(10) unsigned,
created datetime,
last_updated timestamp(14),
PRIMARY KEY (user_id),
KEY email_idx (email),
KEY lastname_idx (lastname),
KEY userdir_idx (userdir)

);

Although the invention is described herein with reference to the preferred embodiment, one skilled in the art will readily appreciate that other applications may be substituted for those set forth herein without departing from the spirit and scope of the present invention. Accordingly, the invention should only be limited by the claims included below.

1. A method for automatic conversion of electronic mail to a site on a global telecommunications network, comprising the steps of:
providing a portal where a global telecommunications network user can post and modify material on said portal using their existing email client;
said user sending electronic mail to said portal;
reading said electronic mail with a handler;
said handler determining if said electronic mail is a valid request to post;
if so, processing said electronic mail in request process logic;
creating one or more uniform resource locators for said electronic mail, said uniform resource locators defining a site address on said global telecommunications network;
said user optionally attaching one or more files to said electronic mail, which files are linked to said posted material;
optionally verifying said user to ensure that said post is a valid post;
storing information about said user and said post in a database;
processing said information; formatting said electronic mail for hyper text markup language viewing on a site that is accessed at said site address;
said portal hosting said site; and
optionally sending an email to said user indicating that said electronic mail is now a page at said site, and that said page is ready for viewing.

2. The method of claim 1, further comprising the step of:
formatting said post to provide a suitable appearance.

3. The method of claim 1, further comprising the steps of:
staging said post;
instituting a verification process to ensure that said user did indeed generate said post;
if said user's request is verified, then flagging said post as viewable; and
sending an email to said user to indicate said uniform resource locator for said posted information.

4. The method of claim 1, further comprising any of the steps of:
providing an automatic electronic mail notification of a group of electronic mail users via an optional process;
providing a process by which said site is submitted to site searching programs;
performing any processes within said method for payment by said user.

5. The method of claim 1, further comprising the step of:
said user forwarding said uniform resource locator for said site to third parties.

6. The method of claim 1, said verify user process further comprising the steps of:
sending an electronic mail to a registered electronic mail address of said user;
asking said user to respond;
said system comparing said response to a database;
if said post is a valid post, flagging said post as viewable; and
if said post is not a valid post, sending a rejection and encouraging registration and reposting.

7. The apparatus of claim 1, wherein said user information comprises any of:
name, password, email, and zip code.

8. The apparatus of claim 1, wherein said user posts comprise any of:
unique ID, owner, URL info, post status, subject, body, date created, date last updated, and number of times viewed.

9. A method for automatic conversion of electronic mail to a site on a global telecommunications network, comprising the steps of:
visiting a site directly to register via a registration process;
alternatively creating said site directly;
transferring said site into an electronic mail client which is either of a client that is hosted on a user's computer and a network based electronic mail client;
said user optionally attaching one or more files to said electronic mail;
said user sending said electronic mail to said portal;
said portal routing said electronic mail to a handler and processing a request;
if a command is not recognized, then said request is routed to a rejection process handler;
if said command is recognized, then said request is routed to a verify user process.

10. The method of claim 9, further comprising the step of:
formatting said post to provide a suitable appearance.

11. The method of claim 9, further comprising the steps of:
staging said post;
instituting a verification process to ensure that said user did indeed generate said post;
if said user's request is verified, then flagging said post as viewable; and
sending an email to said user to indicate said uniform resource locator for said posted information.

12. The method of claim 9, further comprising any of the steps of:
providing an automatic electronic mail notification of a group of electronic mail users via an optional process;
providing a process by which said site is submitted to site searching programs;
performing any processes within said method for payment by said user.

13. The method of claim 9, further comprising the step of:
said user forwarding said uniform resource locator for said site to third parties.

14. The method of claim 9, said verify user process further comprising the steps of:
sending an electronic mail to a registered electronic mail address of said user;
asking said user to respond;
said system comparing said response to a database;
if said post is a valid post, flagging said post as viewable; and
if said post is not a valid post, sending a rejection and encouraging registration and reposting.

15. An apparatus for automatic conversion of electronic mail to a site on a global telecommunications network, comprising:
an electronic mail handling process for handling electronic mail-based requests from global telecommunications network users, for sending electronic mail to users to ask for verification of their electronic mail address, and for providing information about a status of a user request; wherein both outbound and inbound electronic mail handling is provided;
a request process for providing post, replace, delete, and verify functions; said request process performing uniform resource locator creation, applying updating or inserting rules for same subject and user post, performing verification of user and process state of post, and applying rules for formatting a site page from electronic mail;
a data storage process by which posted information posted is stored in a database, wherein said database schema includes user information, user posts, and logs; and
a site hosting process for dynamic page creation, database interaction, user session data manipulation, page caching, and email delivery.

16. The apparatus of claim 15, said electronic mail handling process further comprising:
an outbound process for sending hypertext markup language and text email to global telecommunications network users with customized content and reply addressing.

17. The apparatus of claim 15, said electronic mail handling process further comprising:
an inbound process for handling electronic mail coming in to multiple mail boxes, filtering unwanted messages, and directing valid requests to an appropriate functional process.

18. The apparatus of claim 15, wherein said user information comprises any of:
name, password, email, and zip code.

19. The apparatus of claim 15, wherein said user posts comprise any of:
unique ID, owner, URL info, post status, subject, body, date created, date last updated, and number of times viewed.

20. The apparatus of claim 15, wherein said logs comprise:
tables for logging user actions and process actions.

21. The apparatus of claim 15, further comprising any of:
firewall security; post formatting; hardware sizing; bandwidth sizing; load balancing; redundancy; and data backups.

22. The apparatus of claim 15, said request process further comprising a module for recognizing one or more commands described in an addressee field of said electronics message.

23. The method of claim 15, further comprising the step of: formatting said post to provide a suitable appearance.

24. A method for automatic conversion of electronic mail to a site on a global telecommunications network, comprising the steps of:
providing a portal where a global telecommunications network user can post and modify material on said portal using their existing email client;
creating one or more uniform resource locators for said electronic mail, said uniform resource locators defining a site address on said global telecommunications network; and
formatting said electronic mail for hyper text markup language viewing on a site that is accessed at said site address.

25. The method of claim 24, further comprising the steps of:
visiting a site directly to register via a registration process;
alternatively creating said site directly;
transferring said site into an electronic mail client which is either of a client that is hosted on a user's computer and a network based electronic mail client;
said user optionally attaching one or more files to said electronic mail;
said user sending said electronic mail to a portal by using a specified electronic mail address;
said portal routing said electronic mail to a handler and processing a request;
if a command is not recognized, then said request is routed to a rejection process handler;
if said command is recognized, then said request is routed to a verify user process.

26. The method of claim 24, further comprising the step of:
formatting said post to provide a suitable appearance.

27. The method of claim 24, further comprising the steps of:
staging said post;
instituting a verification process to ensure that said user did indeed generate said post;
if said user's request is verified, then flagging said post as viewable; and
sending an email to said user to indicate said uniform resource locator for said posted information.

28. The method of claim 24, further comprising any of the steps of:
providing an automatic electronic mail notification of a group of electronic mail users via an optional process;
providing a process by which said site is submitted to site searching programs;
performing any processes within said method for payment by said user.

29. The method of claim 24, further comprising the step of:
said user forwarding said uniform resource locator for said site to third parties.

30. The method of claim 24, said verify user process further comprising the steps of:
sending an electronic mail to a registered electronic mail address of said user;
asking said user to respond;
said system comparing said response to a database;
if said post is a valid post, flagging said post as viewable; and
if said post is not a valid post, sending a rejection and encouraging registration and reposting.

31. An apparatus for automatic conversion of electronic mail to a site on a global telecommunications network, comprising:
an electronic mail handling process for handling electronic mail-based requests from global telecommunications network users;
a request process for performing uniform resource locator creation, and applying rules for formatting a site page from electronic mail; and
a site hosting process for dynamic page creation, and user session data manipulation.

32. The apparatus of claim 31, said electronic mail handling process further comprising:
an outbound process for sending hypertext markup language and text email to global telecommunications network users with customized content and reply addressing.

33. The apparatus of claim 31, said electronic mail handling process further comprising:
an inbound process for handling electronic mail coming in to multiple mail boxes, filtering unwanted messages, and directing valid requests to an appropriate functional process.

34. The apparatus of claim 31, wherein said user information comprises any of:
name, password, email, and zip code.

35. The apparatus of claim 31, wherein said user posts comprise any of:
unique ID, owner, URL info, post status, subject, body, date created, date last updated, and number of times viewed.

36. The apparatus of claim 31, wherein said logs comprise:
tables for logging user actions and process actions.

37. The apparatus of claim 31, further comprising any of:
firewall security; post formatting; hardware sizing; bandwidth sizing; load balancing; redundancy; and data backups.

38. The apparatus of claim 31, said request process further comprising a module for recognizing one or more commands described in an addressee field of said electronics message.
